(19) United States
(12) Patent Application Publication
(10) Pub. No.: US 2025/0310472 A1
(43) Pub. Date: Oct. 2, 2025

(54) INFORMATION PROCESSING METHOD, INFORMATION PROCESSING DEVICE, AND PROJECTOR

(71) Applicant: SEIKO EPSON CORPORATION, Tokyo (JP)

(72) Inventor: Minoru YOKOBAYASHI, MATSUMOTO-SHI (JP)

(21) Appl. No.: 19/087,812

(22) Filed: Mar. 24, 2025

(30) Foreign Application Priority Data
Mar. 29, 2024 (JP) 2024-055574

(51) Int. Cl. H04N 5/74

(52) U.S. Cl. CPC H04N 5/74

(57) ABSTRACT

An information processing method includes: acquiring, from a projector projecting an image onto a projection surface, error information indicating an error related to optically detecting a position of an indicator on the projection surface executed by the projector, via a network; and displaying the acquired error information.

The present application is based on, and claims priority from JP Application Serial Number 2024-055574, filed Mar. 29, 2024, the disclosure of which is hereby incorporated by reference herein in its entirety.

### BACKGROUND

### 1. Technical Field

The present disclosure relates to an information processing method, an information processing device, and a projector.

### 2. Related Art

JP-A-2018-160265 discloses a light-emitting device that emits detection light to a detection area where positions indicated by a first indicator and a second indicator are detected, and a projector that detects the positions indicated by the first indicator and the second indicator in the detection area. The projector includes an image pickup unit that captures an image of the detection area, and a position detector that detects at least one of an image of light emitted from the first indicator and an image of the detection light reflected from the second indicator, from captured image data of the image pickup unit, and separately detects the positions indicated by the first indicator and the second indicator, based on the timing of light emission from the first indicator and the light-emitting device.

JP-A-2018-160265 is an example of the related art.

In a projector that performs display control according to the position of an indicator as in the technique of JP-A-2018-160265, a device or processing for implementing the detection and drawing control of the indicator may fail to operate normally. Various causes of this failure to operate normally are conceivable, such as the use environment of the projector, an erroneous operation by a user, and a malfunction of the device for detection, and therefore it is difficult to grasp the cause when support staff is in a remote place.

### SUMMARY

According to an aspect of the present disclosure, an information processing method includes: acquiring, from a projector projecting an image onto a projection surface, error information indicating an error related to optically detecting a position of an indicator on the projection surface executed by the projector, via a network; and displaying the acquired error information.

According to another aspect of the present disclosure, an information processing device includes: a display device that displays an image; and a control device that executes acquiring, from a projector projecting an image onto a projection surface, error information indicating an error related to optically detecting a position of an indicator on the projection surface executed by the projector, via a network, and displaying the acquired error information on the display device.

According to still another aspect of the present disclosure, a projector includes: a first optical device that projects an image onto a projection surface; a second optical device that emits light to an indicator and receives light from the indicator; and a control device that executes optically detecting a position of the indicator on the projection surface, based on a signal output from the second optical device, and transmitting error information indicating an error related to the detecting via a network.

### BRIEF DESCRIPTION OF THE DRAWINGS

FIG. 1 is a block diagram showing a schematic configuration of a projector management system.

FIG. 2 is a block diagram showing a schematic configuration of an information processing device.

FIG. 3 shows an example of a circumstance where a projector is used.

FIG. 4 is a block diagram showing a schematic configuration of the projector.

FIG. 5 is a flowchart showing processing executed by a second control device of the projector.

FIG. 6 is a flowchart showing processing executed by a first control device of the information processing device.

### DESCRIPTION OF EMBODIMENTS

An embodiment of the present disclosure will now be described with reference to the drawings. In the drawings described below, the scale of each member may be different from the actual scale in order to show each member in a recognizable size.

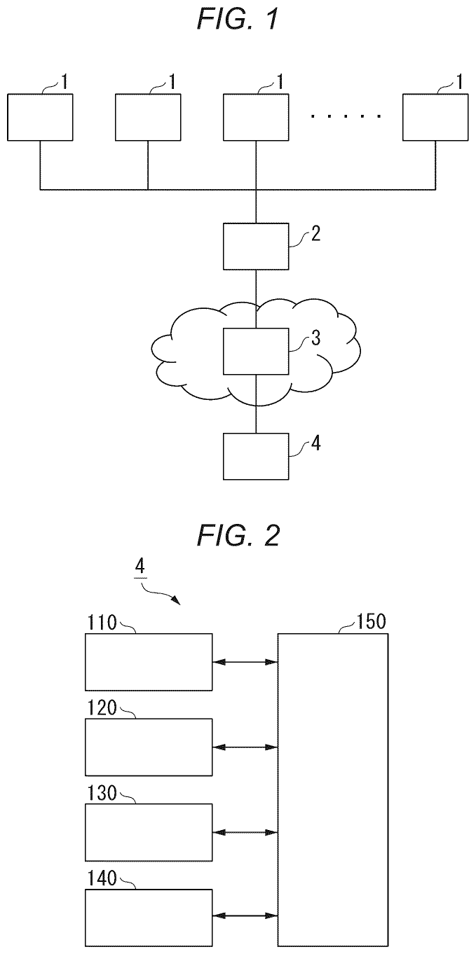

FIG. 1 is a block diagram showing a schematic configuration of a projector management system according to the present embodiment. As shown in FIG. 1, the projector management system according to the present embodiment includes a plurality of projectors 1, a monitoring terminal 2, a cloud server 3, and an information processing device 4.

The projector 1 projects an image onto a projection surface. The projector 1 optically detects the position of an indicator on the projection surface and performs image processing based on the position of the indicator. For example, the projector 1 performs processing of drawing a figure, a character, or a symbol at the position of the indicator, processing of drawing a figure along the trajectory of the position of the indicator, processing of deleting a figure, a character, or a symbol that is drawn, and the like. The position of the indicator on the projection surface is a position indicated by the tip of the indicator on the projection surface. In the present embodiment, as an example, the position of the indicator is represented by two-dimensional coordinate values.

The monitoring terminal 2 communicates with each of the plurality of projectors 1. For example, the monitoring terminal 2 communicates with each of the plurality of projectors 1 via a wired local area network (LAN) or a wireless LAN. The monitoring terminal 2 periodically acquires a log from each of the plurality of projectors 1. The log includes various information used for managing the plurality of projectors 1. The log of the projector 1 includes at least error information indicating an error related to optically detecting the position of the indicator on the projection surface. The monitoring terminal 2 transmits logs acquired from each of the plurality of projectors 1 to the cloud server 3 via a network such as the internet.

The cloud server 3 is a server that provides an online storage service for saving various data on a cloud. The cloud server 3 includes a large-capacity storage device and saves a log received from the monitoring terminal 2 via the internet.

The information processing device 4 communicates with the cloud server 3 via the internet. For example, the information processing device 4 is installed at a support center located in a place remote from a facility where the plurality of projectors 1 and the monitoring terminal 2 are installed. The support center is a facility where support staff who supports the management of the plurality of projectors 1 stays. The information processing device 4 is used by the support staff.

The information processing device 4 acquires the logs of the plurality of projectors 1 from the cloud server 3 via the internet. The information processing device 4 displays the acquired logs. When the acquired logs include the error information, the information processing device 4 displays the acquired error information. For example, the information processing device 4 is a laptop personal computer (PC), a desktop PC, a smartphone, or a tablet terminal or the like.

FIG. 2 is a block diagram showing a schematic configuration of the information processing device 4. As illustrated in FIG. 2, the information processing device 4 includes a first communication device 110, a display device 120, a first input device 130, a first storage device 140, and a first control device 150.

The first communication device 110 is a communication interface circuit that controls communication performed between the first control device 150 and an external device. External devices with which the first control device 150 communicates via the first communication device 110 include the above-described cloud server 3. The display device 120 displays an image based on an image signal input from the first control device 150. For example, the display device 120 is a liquid crystal panel or an organic electro-luminescence (EL) panel.

The first input device 130 is a device that accepts an input operation by the support staff to the information processing device 4. When the information processing device 4 is a laptop PC or a desktop PC, the first input device 130 includes at least a keyboard and a mouse. The keyboard and the mouse output a signal corresponding to the operation accepted from the support staff to the first control device 150.

When the information processing device 4 is a smartphone or a tablet terminal, the first input device 130 includes at least a touch sensor. For example, when the touch sensor is a resistive touch sensor or a capacitive touch sensor, the touch sensor provided in the first input device 130 is a transparent plate-like device superimposed on the display surface of the display device 120. As the transparent plate-like touch sensor is superimposed on the display surface of the display device 120 in this way, a touch panel is formed. The touch sensor repeatedly detects a position on the display surface indicated by a finger of the support staff, and outputs a signal corresponding to the detected position to the first control device 150. The touch sensor may detect a position indicated by a device such as a stylus pen instead of the finger of the support staff.

The first storage device 140 includes a nonvolatile memory that stores a program necessary for causing the first control device 150 to execute various processing and various setting data, or the like, and a volatile memory that is used as a temporary saving destination of data when the first control device 150 executes various processing. For example, the nonvolatile memory is an electrically erasable programmable read-only memory (EEPROM) or a flash memory, or the like. The volatile memory is, for example, a random-access memory (RAM) or the like.

The first control device 150 is an arithmetic processing device that controls the overall operation of the information processing device 4 in accordance with a program stored in the first storage device 140. For example, the first control device 150 is configured with one or a plurality of processors such as a central processing unit (CPU). A part or all of the functions of the first control device 150 may be configured with a circuit such as a digital signal processor (DSP), an application-specific integrated circuit (ASIC), a programmable logic device (PLD), or a field-programmable gate array (FPGA). The first control device 150 executes various kinds of processing in parallel or in sequence. The first control device 150 is an example of a control device provided in the information processing device 4.

As will be described later, the first control device 150 executes acquiring, from the projector 1 via the network, error information indicating an error related to optically detecting the position of the indicator on a screen SC, which is executed by the projector 1, and displaying the acquired error information on the display device 120.

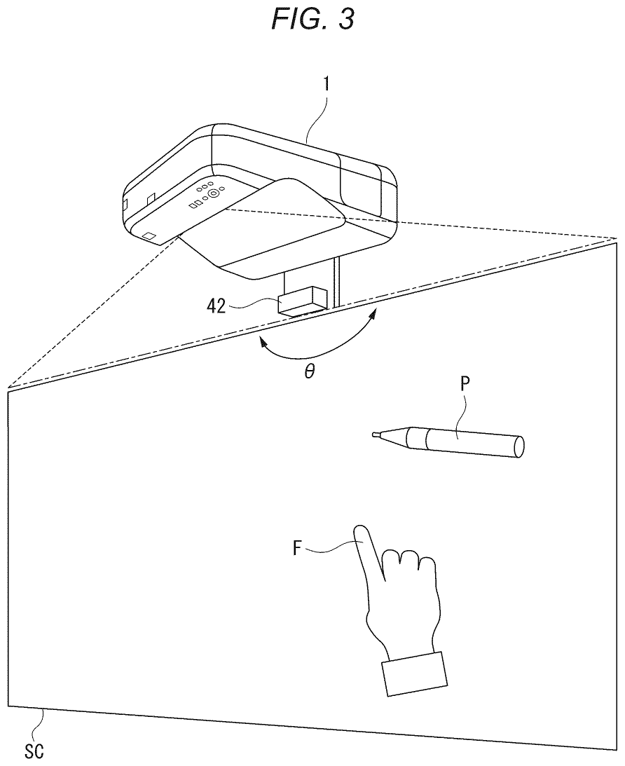

FIG. 3 shows an example of a circumstance where the projector 1 is used. The projector 1 projects an image onto the screen SC. For example, the projector 1 is fixed to a wall surface, not illustrated. The screen SC is installed below the projector 1. The screen SC is an example of a projection surface on which an image is projected by the projector 1. Instead of the screen SC, a wall surface may be used as a projection surface.

The projector 1 displays, on the screen SC, a drawing screen for drawing an object in accordance with position information of an electronic pen P or a finger F of the user. The projector 1 draws an object such as a line, a character, and a figure on the drawing screen, based on the position information of the electronic pen P or the finger F of the user. Thus, the drawing screen displayed on the screen SC is used as an electronic whiteboard.

The electronic pen P includes a light-emitting element that emits infrared light to the tip of the pen, and emits infrared light from the tip of the pen in synchronization with a synchronization signal transmitted from a synchronization device 41 of the projector 1. The electronic pen P includes a light-receiving element that receives infrared light, and receives a synchronization signal of the infrared light from the synchronization device 41, described later. The electronic pen P emits infrared light according to a predetermined sequence at a timing corresponding to the synchronization signal. The projector 1 picks up an image of the infrared light emitted from the electronic pen P, with a camera 43, and acquires position information of the electronic pen P, based on the picked-up image acquired from the camera 43. In FIG. 3, the synchronization device 41 and the camera 43 are not shown.

The projector 1 includes a light-emitting device 42. The light-emitting device 42 includes a light source that emits infrared light. The light-emitting device 42 is disposed between the main body of the projector 1 and the screen SC, and diffuses and emits the infrared light downward in a range of an angle θ. The infrared light emitted from the light-emitting device 42 forms a light layer along the screen SC. In the present embodiment, the angle θ extends to approximately 180 degrees, and a light layer is formed on approximately the entire screen SC. It is preferable that the light layer formed by the light-emitting device 42 is close to the surface of the screen SC. The light-emitting device 42 may include an adjustment mechanism that adjusts the distance or the angle between the layer of light emitted by the light source and the screen SC. The light-emitting device 42 can be omitted when the detection of the finger F of the user is not performed.

The projector 1 picks up, with the camera 43, an image of reflected light generated when the infrared light emitted from the light-emitting device 42 is reflected from the finger F of the user, and acquires position information of the finger F of the user, based on the picked-up image acquired from the camera 43. The electronic pen P and the finger F of the user are examples of the indicator. In the description below, when the electronic pen P and the finger F of the user need not be distinguished from each other, the electronic pen P and the finger F of the user are collectively referred to as the indicator. The electronic pen P is an example of a light-emitting indicator that emits light.

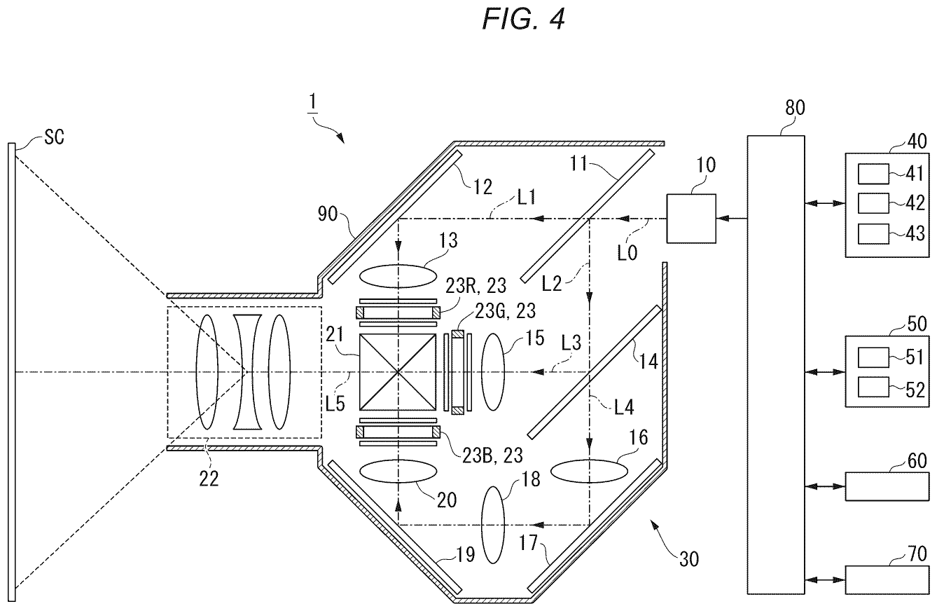

FIG. 4 shows a schematic configuration of the projector 1 according to the present embodiment. As shown in FIG. 4, the projector 1 includes a first optical device 30, a second optical device 40, a second input device 50, a second communication device 60, a second storage device 70, and a second control device 80.

The first optical device 30 projects an image onto the screen SC. The first optical device 30 includes a light source 10, two dichroic mirrors 11 and 14, three reflection mirrors 12, 17, and 19, five relay lenses 13, 15, 16, 18, and 20, a dichroic prism 21, a projection system 22, and three liquid crystal panels 23R, 23G, and 23B.

The light source 10 emits white light L0 to the dichroic mirror 11. For example, the light source 10 is a mercury lamp. The amount of light of the white light L0 emitted from the light source 10 is controlled by the second control device 80.

The dichroic mirror 11 separates the white light L0 into first color light L1 and second color light L2. For example, the first color light L1 is red light, and the second color light L2 is light of a mixed color of green and blue. The dichroic mirror 11 emits the first color light L1 to the reflection mirror 12 and emits the second color light L2 to the dichroic mirror 14.

The dichroic mirror 14 separates the second color light L2 into third color light L3 and fourth color light L4. For example, the third color light L3 is green light; and the fourth color light L4 is blue light. The dichroic mirror 14 emits the third color light L3 to the relay lens 15 and emits the fourth color light L4 to the relay lens 16.

The first color light L1 emitted from the dichroic mirror 11 enters the liquid crystal panel 23R via the reflection mirror 12 and the relay lens 13. The third color light L3 emitted from the dichroic mirror 14 enters the liquid crystal panel 23G via the relay lens 15. The fourth color light L4 emitted from the dichroic mirror 14 enters the liquid crystal panel 23B via the relay lens 16, the reflection mirror 17, the relay lens 18, the reflection mirror 19, and the relay lens 20.

Each of the liquid crystal panels 23R, 23G, and 23B is a liquid crystal panel for image display. The liquid crystal panel 23R is disposed on the optical path of the first color light L1. The liquid crystal panel 23G is disposed on the optical path of the third color light L3. The liquid crystal panel 23B is disposed on the optical path of the fourth color light L4. Hereinafter, when the liquid crystal panels 23R, 23G, and 23B need not be distinguished from each other, the three liquid crystal panels 23R, 23G, and 23B may be collectively referred to as the liquid crystal panel 23.

For example, the liquid crystal panel 23 in the present embodiment is an active drive liquid crystal panel including a thin film transistor (TFT) as a pixel switching element for each pixel. For example, the liquid crystal panel 23 is a vertical alignment (VA) liquid crystal panel. The liquid crystal panel 23 functions as a light modulation device in the projector 1. The liquid crystal panel 23R modulates the first color light L1 of red. The liquid crystal panel 23G modulates the third color light L3 of green. The liquid crystal panel 23B modulates the fourth color light L4 of blue. Although not shown in FIG. 1, the transmittance of the pixels provided in each of the liquid crystal panels 23R, 23G, and 23B is controlled by the second control device 80.

The dichroic prism 21 mixes together the first color light L1 modulated by the liquid crystal panel 23R, the third color light L3 modulated by the liquid crystal panel 23G, and the fourth color light L4 modulated by the liquid crystal panel 23B and thus generates image light L5 representing a color image. The dichroic prism 21 emits the image light L5 to the projection system 22. The projection system 22 projects the image light L5 in an enlarged form onto the screen SC. As the image light L5 is projected onto the screen SC, the color image is displayed on the screen SC.

In the casing of the projector 1, the dichroic mirrors 11 and 14, the reflection mirrors 12, 17, and 19, the relay lenses 13, 15, 16, 18, and 20, the dichroic prism 21, the projection system 22, and the liquid crystal panels 23R, 23G, and 23B are accommodated, for example, inside a case 90 made of resin. The case 90 is configured to prevent light other than the white light L0 emitted from the light source 10 from entering the liquid crystal panel 23.

The second optical device 40 emits infrared light to the indicator and receives infrared light from the indicator. The second optical device 40 includes the synchronization device 41, the light-emitting device 42, and the camera 43. The camera 43 is an example of an image pickup device.

The synchronization device 41 includes a light source that emits infrared light, and transmits infrared light as a synchronization signal in accordance with an instruction from the second control device 80. As described above, the electronic pen P emits infrared light from the tip of the pen in synchronization with the synchronization signal transmitted from the synchronization device 41. The light-emitting device 42 emits infrared light that forms a light layer along the screen SC in accordance with an instruction from the second control device 80. The light-emitting device 42 is as described above.

The projector 1 includes the camera 43 for acquiring the position information of the electronic pen P or the finger F of the user. The camera 43 includes an image pickup element that receives infrared light emitted by the electronic pen P and reflected light generated when the infrared light emitted from the light-emitting device 42 is reflected from the finger F of the user, an optical system that forms an image on the image pickup element, and a diaphragm that limits the light entering the image pickup element. The image pickup element is, for example, a charge-coupled device (CCD) or a complementary metal-oxide semiconductor (CMOS) that detects infrared light and visible light. The camera 43 captures an image of a range including the screen SC in accordance with an instruction from the second control device 80, and outputs captured image data representing the picked-up image to the second control device 80.

The second input device 50 is a device that accepts an input operation by a user to the projector 1. For example, the second input device 50 includes an operator 51 and a light receiver 52. The operator 51 includes a plurality of operation keys provided in the projector 1. For example, the operation keys include a power key, a menu call key, a direction key, an enter key, and a volume control key. The operation keys may be hardware keys or may be software keys displayed on a touch panel provided in the projector 1. The operator 51 outputs an electrical signal generated by an operation of each operation key by the user, as an operation signal, to the second control device 80.

The light receiver 52 includes a photoelectric conversion circuit that receives infrared light transmitted from a remote controller (not shown) of the projector 1 and converts the infrared light into an electrical signal. The light receiver 52 outputs the electrical signal acquired by the photoelectric conversion of infrared light, as a remote operation signal, to the second control device 80. The remote controller is provided with a plurality of operation keys similarly to the operator 51. The remote controller converts an electrical signal generated in response to an operation of each operation key provided on the remote controller by the user, into infrared light and transmits the infrared light to the projector 1. That is, the remote operation signal output from the light receiver 52 is substantially the same as the electrical signal generated when each operation key of the remote controller is operated by the user. When the remote controller transmits a radio signal according to a near field communication standard such as Bluetooth (trademark registered), a receiving device that receives the radio signal may be provided instead of the light receiver 52.

The second communication device 60 is a communication interface circuit that controls communication performed between the second control device 80 and an external device. The external device with which the second control device 80 communicates via the second communication device 60 includes the foregoing monitoring terminal 2.

The second storage device 70 includes a nonvolatile memory that stores a program necessary for causing the second control device 80 to execute various processing, various setting data, and the like, and a volatile memory that is used as a temporary saving destination of data when the second control device 80 executes various processing. For example, the nonvolatile memory is an EEPROM or a flash memory. The volatile memory is, for example, a RAM.

The second control device 80 is an arithmetic processing device that controls the overall operation of the projector 1 in accordance with a program stored in the second storage device 70. For example, the second control device 80 includes one or a plurality of processors such as a CPU. A part or all of the functions of the second control device 80 may be configured with a circuit such as a DSP, an ASIC, a PLD, or an FPGA. The second control device 80 executes various kinds of processing in parallel or in sequence. The second control device 80 is an example of a control device provided in the projector 1.

As will be described later, the second control device 80 executes optically detecting the position of the indicator on the screen SC, based on the signal output from the second optical device 40, and transmitting error information indicating an error related to optically detecting the position of the indicator via the network.

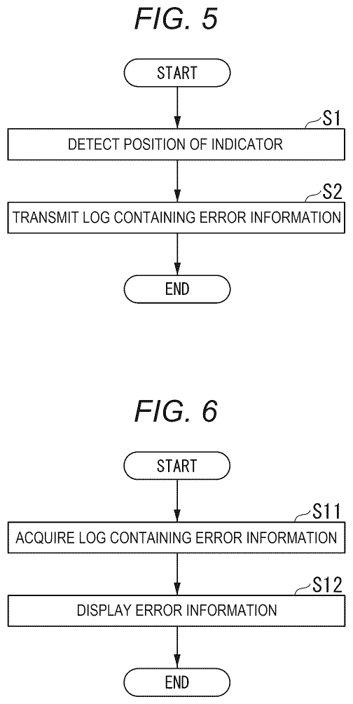

FIG. 5 is a flowchart showing each processing executed by the second control device 80 of the projector 1. The second control device 80 executes a program stored in the second storage device 70 and thus executes each processing shown in FIG. 5.

As shown in FIG. 5, the second control device 80 detects the position of the electronic pen P or the finger F of the user in the state where a drawing screen that is an electronic whiteboard is displayed on the screen SC (step S1). Specifically, the second control device 80 instructs the synchronization device 41 to transmit a synchronization signal and instructs the light-emitting device 42 to emit infrared light at a predetermined timing.

The electronic pen P emits infrared light from the tip of the pen in synchronization with the synchronization signal transmitted from the synchronization device 41 of the projector 1. The light-emitting device 42 emits infrared light at a timing designated by the second control device 80. The second control device 80 controls the synchronization device 41 and the light-emitting device 42 as described above, and instructs the camera 43 to perform an image pickup operation at a predetermined timing.

The camera 43 captures an image of a range including the screen SC at the timing designated by the second control device 80, and outputs picked-up image data representing the picked-up image to the second control device 80. The picked-up image includes an image area representing reflected light generated when infrared light emitted by the electronic pen P or infrared light emitted from the light-emitting device 42 is reflected from the finger F of the user.

The second control device 80 acquires position information of the electronic pen P or the finger F of the user, based on the picked-up image acquired from the camera 43. For example, as a method in which the second control device 80 acquires the position information of the electronic pen P or the finger F of the user, the method disclosed in JP-A-2018-160265 can be employed. Thus, in the present embodiment, the detailed description of the method in which the second control device 80 acquires the position information of the electronic pen P or the finger F of the user is omitted.

Step S1 is not limited to the processing of detecting the position of the indicator, and may include adjustment processing for detecting the position of the indicator. For example, step S1 may include adjustment processing for at least one of the synchronization device 41, the light-emitting device 42, and the camera 43. Specifically, the second control device 80 may transmit a signal for operation check to each of these devices and may receive a response signal to check whether each of the devices operates normally. The second control device 80 may perform calibration processing of converting the position of the indicator in the coordinate system of the picked-up image picked up by the camera 43 to a position in the coordinate system of the liquid crystal panel 23. The second control device 80 may perform processing for adjusting the irradiation angle of the infrared light emitted by the light-emitting device 42.

A first example of the calibration processing will be described. The calibration processing may be started by an operation of the second input device 50 or the remote controller by the user. The second control device 80 controls the first optical device 30 to project a pattern image for calibration onto the screen SC. The pattern image is an image including a plurality of figures such as rectangles. The second control device 80 controls the camera 43 to acquire a picked-up image of the screen SC including the pattern image. The second control device 80 determines a conversion formula for converting a position in the picked-up image to a position in the liquid crystal panel 23, based on the positional relationship between the position of the figure in the picked-up image and the position of the figure in the liquid crystal panel 23.

As a second example of the calibration processing, the second control device 80 may perform calibration based on an operation on the screen SC by the user. In this case, the second control device 80 controls the first optical device 30 to project a plurality of figures included in the image for calibration onto the screen SC. The user sequentially touches a plurality of figures with the electronic pen P. The order of touching is designated by the second control device 80 according to the display order of the figures. The second control device 80 controls the light emission timing of the electronic pen P by the synchronization device 41, and acquires by the camera 43 a picked-up image of the screen SC when a touch operation is performed. The second control device 80 determines a conversion formula for converting a position in the picked-up image to a position in the liquid crystal panel 23, based on the positional relationship between the position of the infrared light of the electronic pen P in the picked-up image and the position of the figure in the liquid crystal panel 23.

When the light-emitting device 42 has an adjustment mechanism, the second control device 80 may perform processing for adjusting the irradiation angle of the infrared light emitted by the light-emitting device 42. This processing is processing for adjusting the irradiation angle of the infrared light emitted by the light-emitting device 42 so that the layer of the light emitted by the light-emitting device 42 covers substantially the entire screen SC in proximity to the surface of the screen SC. For example, the second control device 80 causes the light-emitting device 42 to emit infrared light, then detects reflected light from a plurality of markers that are arranged on the screen SC and that reflect infrared light, using the camera 43, and thus detects the position of the marker on the screen SC. The second control device 80 displays a marker image at the position of the detected marker. The user operates the adjustment mechanism with reference to the image and thus adjusts the irradiation angle of the infrared light. The adjustment mechanism may be controlled by the second control device 80.

The processing of step S1 as described above is an example of optically detecting the position of the indicator on the screen SC, based on the signal output from the second optical device 40. The picked-up image data output from the camera 43 to the second control device 80 is an example of the signal output from the second optical device 40. The second control device 80 controls the first optical device 30 so that an object such as a line, a character, or a figure is drawn on the drawing screen, based on the position information of the electronic pen P or the finger F of the user.

When the occurrence of an error related to optically detecting the position of the indicator is detected during the execution of the processing of step S1, the second control device 80 transmits a log including error information indicating the detected error to the monitoring terminal 2 via the second communication device 60 (step S2). Specifically, when an error occurs in any of the above-described processing, the second control device 80 acquires the error ID from the second storage device 70, based on the return value of the control signal, or the like. The error ID is, for example, a two-digit code that is associated with the content of the error on a one-to-one basis. When there are a plurality of causes or contents of errors in one processing, an error ID and a detail code indicating details of the error may be acquired. For example, when a part of the figures included in the pattern image is not detected in the calibration in the above-described first example, the presence of an obstacle in the image, the influence of external light, or the like, may be the cause. Also, when the conversion formula cannot be determined even if all the figures are detected, a distortion of the projection surface may be the cause. A detail code may be prepared for each cause. The error information preferably includes at least an error ID, identification information uniquely indicating the projector 1 where the error is generated, and the date and time when the error is generated. The error information may include an error ID and a detail code.

The monitoring terminal 2 transmits logs acquired from each of the plurality of projectors 1 to the cloud server 3 via a network such as the internet. The cloud server 3 stores the log received from the monitoring terminal 2 in a storage device installed in the cloud server 3.

The processing of step S2 as described above is an example of transmitting error information indicating an error related to optically detecting the position of the indicator via the network. While an example in which each projector 1 transmits a log including error information to the cloud server 3 via the monitoring terminal 2 is described in the present embodiment, each projector 1 may transmit a log including error information to the cloud server 3 without using the monitoring terminal 2. In this case, the second communication device 60 communicates with the cloud server 3.

Since the second control device 80 of each projector 1 periodically executes the processing shown in FIG. 5 as described above, the log of each projector 1 is accumulated in the cloud server 3. The logs accumulated in the cloud server 3 include a log including error information as described above.

When an abnormality occurs in any one of the plurality of projectors 1, the user of each of the plurality of projectors 1 notifies the support staff of the occurrence of the abnormality and asks the support staff for the coping method. Upon receiving the contact from the user, the support staff operates the first input device 130 of the information processing device 4 and thus instructs the information processing device 4 to display the log of the projector 1 where the abnormality is generated.

FIG. 6 is a flowchart showing each processing executed by the first control device 150 of the information processing device 4. The first control device 150 executes a program stored in the first storage device 140 and thus executes each processing shown in FIG. 6.

As shown in FIG. 6, when the first control device 150 accepts an operation of giving an instruction to display the log of the projector 1 from the support staff via the first input device 130, the first control device 150 acquires the log of the projector 1 designated by the support staff from the cloud server 3 via the first communication device 110 (step S11). The first control device 150 causes the display device 120 to display the error information included in the log acquired from the cloud server 3 (step S12).

The processing of step S11 as described above is an example of acquiring, from the projector 1 via the network, error information indicating an error related to optically detecting the position of the indicator on the screen SC, which is executed by the projector 1. The processing of step S12 as described above is an example of causing the display device 120 to display the acquired error information.

Optically detecting the position of the indicator includes picking up an image of the screen SC, using an image pickup device. The error related to optically detecting the position of the indicator includes an error related to the image pickup device. For example, the error related to the image pickup device is that the position of the indicator cannot be detected due to a malfunction of the image pickup device, strong external light such as solar light or fluorescent light entering the screen SC or the light receiver of the image pickup device, the presence of an obstacle between the image pickup device and the screen SC, or the like.

Optically detecting the position of the indicator includes detecting the position of the finger F of the user, based on reflected light generated when infrared light emitted from the light-emitting device 42 is reflected from the finger F of the user. The error related to optically detecting the position of the indicator includes an error related to the light-emitting device 42. For example, the error related to the light-emitting device 42 is that the position of the finger F of the user cannot be detected due to a malfunction of the light-emitting device 42, strong external light such as solar light or fluorescent light entering the screen SC, the presence of an obstacle between the light-emitting device 42 and the screen SC, or the like.

Optically detecting the position of the indicator includes detecting the position of the electronic pen P, based on the infrared light emitted from the electronic pen P. The error related to optically detecting the position of the indicator includes an error related to the electronic pen P. For example, the error related to the electronic pen P is that the position of the electronic pen P cannot be detected due to a malfunction of the electronic pen P, strong external light such as solar light or fluorescent light entering the screen SC, the presence of an obstacle between the electronic pen P and the screen SC, or the like.

For example, the error information is first error information including both an on-screen display (OSD) message number and a detail code, or second error information including the OSD message number, of the OSD message number and the detail code. That is, the second error information includes the OSD message number but does not include the detail code. The OSD message number is the number of a message displayed on the OSD screen according to the content of the error. The detail code is an error code attached to the OSD message. The OSD is an image displayed by the projector 1, and is used to present a menu screen for controlling the projector 1 and various information related to the projector 1. When an error occurs, the projector 1 may display a message corresponding to the error by OSD in step S2. The content of the message preferably includes the type of the error and the description of the coping method, and may include the error ID or the detail code. The content of the message is stored in the second storage device 70 in association with the OSD message number. The OSD message number is stored in the second storage device 70 in association with the error ID or the detail code, and the second control device 80 causes the first optical device 30 to display the OSD message, based on the error ID or the detail code.

By checking the OSD message number and the detail code included in the error information displayed on the display device 120 of the information processing device 4, the support staff can easily grasp the content of the error generated in the projector 1 receiving the contact from the user, and the coping method thereof. As a result, the support staff can give appropriate advice to the user about the abnormality occurring in any one of the plurality of projectors 1.

As the first control device 150 of the information processing device 4 executes the processing shown in FIG. 6, the information processing method according to the present embodiment as described below is implemented.

That is, the information processing method according to the present embodiment includes acquiring, from the projector 1 via the network, error information indicating an error related to optically detecting the position of the indicator on the screen SC, executed by the projector 1 projecting an image onto the screen SC, and displaying the acquired error information.

According to the present embodiment as described above, error information indicating an error related to optically detecting the position of the indicator on the screen SC is acquired from the projector 1, and the acquired error information is displayed, and therefore the support staff can grasp the cause of the inability of the projector 1 to normally perform display control corresponding to the position of the indicator even when the support staff is in a place remote from the place where the projector 1 is installed.

In the information processing method according to the present embodiment, optically detecting the position of the indicator includes picking up an image of the screen SC by using the image pickup device, and the error related to optically detecting the position of the indicator includes an error related to the image pickup device. The error related to the image pickup device is that a response signal to a signal for operation check from the second control device 80 is an abnormal value, that the coupling of the image pickup device is not detected, that image pickup is not performed, or the like.

According to the present embodiment as described above, optically detecting the position of the indicator includes picking up an image of the screen SC by using the image pickup device, and the error related to optically detecting the position of the indicator includes an error related to the image pickup device, and therefore the support staff can grasp the error related to the image pickup device as the cause of the inability of the projector 1 to normally perform display control corresponding to the position of the indicator.

In the information processing method according to the present embodiment, optically detecting the position of the indicator includes detecting the position of the finger F of the user, based on reflected light generated when infrared light emitted from the light-emitting device 42 is reflected from the finger F of the user, and the error related to optically detecting the position of the indicator includes an error related to the light-emitting device 42. The error related to the light-emitting device 42 is, for example, that the coupling of the light-emitting device 42 is not detected, that a response signal to a signal for operation check is an abnormal value, or that a marker is not detected in the processing for adjusting the irradiation angle of the infrared light emitted by the light-emitting device 42, or the like.

According to the present embodiment as described above, optically detecting the position of the indicator includes detecting the position of the finger F of the user, based on the reflected light generated when the infrared light emitted from the light-emitting device 42 is reflected from the finger F of the use, and the error related to optically detecting the position of the indicator includes an error related to the light-emitting device 42, and therefore the support staff can grasp the error related to the light-emitting device 42 as the cause of the inability of the projector 1 to normally perform display control corresponding to the position of the indicator.

In the information processing method according to the present embodiment, the indicator includes the electronic pen P emitting light, and optically detecting the position of the indicator includes detecting the position of the electronic pen P, based on the infrared light emitted from the electronic pen P, and the error related to optically detecting the position of the indicator includes an error related to the electronic pen P. The error related to the electronic pen P is, for example, a matter described by way of example in the description of the detail code. The above-described various errors are examples and are not limiting.

According to the present embodiment as described above, optically detecting the position of the indicator includes detecting the position of the electronic pen P, based on the infrared light emitted from the electronic pen P, and the error related to optically detecting the position of the indicator includes an error related to the electronic pen P, and therefore the support staff can grasp the error related to the electronic pen P as the cause of the inability of the projector 1 to normally perform display control corresponding to the position of the indicator.

In the information processing method according to the present embodiment, the error information is either the first error information including both the OSD message number and the detail code, or the second error information including the OSD message number, of the OSD message number and the detail code.

According to the present embodiment as described above, the support staff checks the OSD message number and the detail code included in the displayed error information and thus can easily grasp the content of the error occurring in the projector 1 and the coping method thereof.

The information processing device 4 according to the present embodiment includes the display device 120, which displays an image, and the first control device 150, which executes acquiring, from the projector 1 via the network, error information indicating an error related to optically detecting the position of the indicator on the screen SC, executed by the projector 1 projecting an image onto the screen SC, and displaying the acquired error information on the display device 120.

In the information processing device 4 according to the present embodiment as described above, the first control device 150 executes acquiring, from the projector 1 via the network, error information indicating an error related to optically detecting the position of the indicator on the screen SC, executed by the projector 1 projecting an image onto the screen SC, and displaying the acquired error information on the display device 120, and therefore the support staff can grasp the cause of the inability of the projector 1 to normally perform display control corresponding to the position of the indicator even when the support staff is in a place remote from the place where the projector 1 is installed.

The projector 1 according to the present embodiment includes the first optical device 30, which projects an image onto the screen SC, the second optical device 40, which emits infrared light to the indicator and receives infrared light from the indicator, and the second control device 80, which executes optically detecting the position of the indicator on the screen SC, based on the signal output from the second optical device 40, and transmitting error information indicating an error related to optically detecting the position of the indicator via the network.

In the projector 1 according to the present embodiment as described above, the second control device 80 executes optically detecting the position of the indicator on the screen SC, based on the signal output from the second optical device 40, and transmitting the error information indicating the error related to optically detecting the position of the indicator via the network, and therefore the support staff can grasp the cause of the inability of the projector 1 to normally perform display control corresponding to the position of the indicator even when the support staff is in a place remote from the place where the projector 1 is installed.

While an embodiment of the present disclosure is described above, the technical scope of the present disclosure is not limited to the above embodiment and various modifications can be made without departing from the spirit and scope of the present disclosure.

In the above embodiment, the error related to the image pickup device, the error related to the light-emitting device 42, and the error related to the electronic pen P are described as examples of the error related to optically detecting the position of the indicator, but the content of the error according to the present disclosure is not limited to these examples. When the monitoring terminal 2 acquires a log including the error information, the monitoring terminal 2 may transmit an e-mail to the information processing device 4 and thus notify the support staff that an error is generated in one of the projectors 1. While an example in which the support staff uses the log stored in the cloud server 3 is described in the above embodiment, the manager of the projector 1 may use the log for maintenance.

### SUMMARY OF PRESENT DISCLOSURE

The present disclosure will be summarized below in the form of appendices.

(Appendix 1) An information processing method includes: acquiring, from a projector projecting an image onto a projection surface, error information indicating an error related to optically detecting a position of an indicator on the projection surface executed by the projector, via a network; and displaying the acquired error information.

The information processing method according to Appendix 1 includes: acquiring, from the projector, error information indicating an error related to optically detecting the position of the indicator on the projection surface executed by the projector, via the network; and displaying the acquired error information, and therefore the support staff can grasp the cause of the inability of the projector to normally perform display control corresponding to the position of the indicator even when the support staff is in a place remote from the place where the projector is installed.

(Appendix 2) In the information processing method according to Appendix 1, the detecting includes picking up an image of the projection surface by using an image pickup device, and the error includes an error related to the image pickup device.

In the information processing method according to Appendix 2, the detecting includes picking up an image of the projection surface by using the image pickup device, and the error includes an error related to the image pickup device, and therefore the support staff can grasp the error related to the image pickup device as the cause of the inability of the projector to normally perform display control corresponding to the position of the indicator.

(Appendix 3) In the information processing method according to Appendix 1 or 2, the detecting includes detecting the position of the indicator, based on reflected light generated when light emitted from a light-emitting device is reflected from the indicator, and the error includes an error related to the light-emitting device.

In the information processing method according to Appendix 3, the detecting includes detecting the position of the indicator, based on reflected light generated when light emitted from the light-emitting device is reflected from the indicator, and the error includes an error related to the light-emitting device, and therefore the support staff can grasp the error related to the light-emitting device as the cause of the inability of the projector to normally perform display control corresponding to the position of the indicator.

(Appendix 4) In the information processing method according to one of Appendices 1 to 3, the indicator includes a light-emitting indicator that emits light, the detecting includes detecting the position of the light-emitting indicator, based on light emitted from the light-emitting indicator, and the error includes an error related to the light-emitting indicator.

In the information processing method according to Appendix 4, the indicator includes the light-emitting indicator that emits light, the detecting includes detecting the position of the light-emitting indicator, based on light emitted from the light-emitting indicator, and the error includes an error related to the light-emitting indicator, and therefore the support staff can grasp the error related to the light-emitting indicator as the cause of the inability of the projector to normally perform display control corresponding to the position of the indicator.

(Appendix 5) In the information processing method according to one of Appendices 1 to 5, the error information is one of first error information including both a message number of a message corresponding to the error and a detail code indicating details of the error, displayed by the projector, and second error information including the message number, of the message number and the detail code.

With the information processing method according to Appendix 5, the support staff checks the message number and the detail code included in the displayed error information and thus can easily grasp the content of the error occurring in the projector and the coping method thereof.

(Appendix 6) An information processing device includes: a display device that displays an image; and a control device that executes acquiring, from a projector projecting an image onto a projection surface, error information indicating an error related to optically detecting a position of an indicator on the projection surface executed by the projector, via a network, and displaying the acquired error information on the display device.

In the information processing device according to Appendix 6, the control device executes acquiring, from the projector, error information indicating an error related to optically detecting the position of the indicator on the projection surface executed by the projector, via the network, and displaying the acquired error information on the display device, and therefore the support staff can grasp the cause of the inability of the projector to normally perform display control corresponding to the position of the indicator even when the support staff is in a place remote from the place where the projector is installed.

(Appendix 7) A projector includes: a first optical device that projects an image onto a projection surface; a second optical device that emits light to an indicator and receives light from the indicator; and a control device that executes optically detecting a position of the indicator on the projection surface, based on a signal output from the second optical device, and transmitting error information indicating an error related to the detecting via a network.

In the projector according to Appendix 7, the control device executes optically detecting the position of the indicator on the projection surface, based on the signal output from the second optical device, and transmitting error information indicating an error related to optically detecting the position of the indicator via the network, and therefore the support staff can grasp the cause of the inability of the projector to normally perform display control corresponding to the position of the indicator even when the support staff is in a place remote from the place where the projector is installed.

What is claimed is:

1. An information processing method comprising:
acquiring, from a projector projecting an image onto a projection surface, error information indicating an error related to optically detecting a position of an indicator on the projection surface executed by the projector, via a network; and
displaying the acquired error information.

2. The information processing method according to claim 1, wherein
the detecting includes picking up an image of the projection surface by using an image pickup device, and
the error includes an error related to the image pickup device.

3. The information processing method according to claim 1, wherein
the detecting includes detecting the position of the indicator, based on reflected light generated when light emitted from a light-emitting device is reflected from the indicator, and
the error includes an error related to the light-emitting device.

4. The information processing method according to claim 1, wherein
the indicator is a light-emitting indicator that emits light,
the detecting includes detecting the position of the light-emitting indicator, based on light emitted from the light-emitting indicator, and
the error includes an error related to the light-emitting indicator.

5. The information processing method according to claim 1, wherein
the error information is one of first error information including both a message number of a message corresponding to the error and a detail code indicating details of the error, displayed by the projector, and second error information including the message number, of the message number and the detail code.

6. An information processing device comprising:
a display device that displays an image; and
a control device that executes
acquiring, from a projector projecting an image onto a projection surface, error information indicating an error related to optically detecting a position of an indicator on the projection surface executed by the projector, via a network, and
displaying the acquired error information on the display device.

7. A projector comprising:
a first optical device that projects an image onto a projection surface;
a second optical device that emits light to an indicator and receives light from the indicator; and
a control device that executes
optically detecting a position of the indicator on the projection surface, based on a signal output from the second optical device, and
transmitting error information indicating an error related to the detecting via a network.
